(19) United States
(12) Patent Application Publication
(10) Pub. No.: US 2015/0035993 A1
(43) Pub. Date: Feb. 5, 2015

(54) SYSTEMS, METHODS, AND MEDIA FOR CALIBRATING A DISPLAY DEVICE

(71) Applicant: Sonic IP, Inc., Santa Clara, CA (US)

(72) Inventors: Geno James, San Diego, CA (US); Jaya Bhagavathula, San Diego, CA (US); Jia Wu, San Diego, CA (US)

(73) Assignee: Sonic IP, Inc., Santa Clara, CA (US)

(21) Appl. No.: 13/959,344

(22) Filed: Aug. 5, 2013

(51) Int. Cl. H04N 17/00

(52) U.S. Cl. CPC H04N 17/004
USPC 348/189

(57) ABSTRACT

Methods, systems, and media for calibrating a display device are provided. In some embodiments, the methods comprise: causing a first test stream to be displayed on the display device; capturing, using a hardware processor, at least one screenshot of the first test stream displayed on the display device; detecting, using the hardware processor, a first test pattern in the screenshot; determining, using the hardware processor, whether the first test pattern contains a distortion; and generating, using the hardware processor, a set of instructions to calibrate the display device in response to determining that the first test pattern contains a distortion.

### TECHNICAL FIELDS

Methods, systems, and media for calibrating a display device are provided. More particularly, the disclosed subject matter relates to automatically certifying and/or calibrating a display device utilizing specialized test streams.

### BACKGROUND OF THE INVENTION

There are many conventional approaches to calibrate a display device that can decode and render audio streams and/or video streams. For example, while a video stream is displayed on a display device, a user can view the displayed video stream and manually adjust the resolution, brightness, contrast, color balance, and other characteristics of the display device. However, manual certification or calibration is time consuming and inaccurate. The result of the calibration heavily relies on the user's skills, lighting, and other factors. In addition, different video inputs provided by different devices (e.g., a set-top box, a DVD player, a Blu-ray player, a gaming console, etc.) may require different settings to achieve desirable display performance. That is, the user may have to manually calibrate the display device for each of the video inputs.

Accordingly, new mechanisms for calibrating display devices are desirable.

### SUMMARY OF THE INVENTION

In view of the foregoing, systems, methods, and media for calibrating display devices are provided. In some embodiments, methods for calibrating a display device are provided, the methods comprising: causing a first test stream to be displayed on the display device; capturing, using a hardware processor, at least one screenshot of the first test stream displayed on the display device; detecting, using the hardware processor, a first test pattern in the screenshot; determining, using the hardware processor, whether the first test pattern contains a distortion; and generating, using the hardware processor, a set of instructions to calibrate the display device in response to determining that the first test pattern contains a distortion.

In some embodiments, systems for calibrating a display device are provided, the systems comprising: at least one hardware processor that is configured to: cause a first test stream to be displayed on the display device; capture at least one screenshot of the first test stream displayed on the display device; detect a first test pattern in the screenshot; determine whether the first test pattern contains a distortion; and generate a set of instructions to calibrate the display device in response to determining that the first test pattern contains a distortion.

In some embodiments, non-transitory computer-readable media containing computer-executable instructions that, when executed by a processing circuitry, cause the processing circuitry to perform a method for calibrating a display device, the method comprising: causing a first test stream to be displayed on the display device; capturing at least one screenshot of the first test stream displayed on the display device; detecting a first test pattern in the screenshot; determining whether the first test pattern contains a distortion; and generating a set of instructions to calibrate the display device in response to determining that the first test pattern contains a distortion.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows a generalized block diagram of an example of an architecture of hardware that can be used to certify and/or calibrate a display device in accordance with some embodiments of the invention;

FIG. 2 shows a flow chart of an example of a process for certifying a display device in accordance with some embodiments of the invention;

FIG. 3 shows a flow chart of an example of a process for certifying and calibrating a display device in accordance with some embodiments of the invention;

FIG. 4 shows an example of a test image that can be used to certify and/or calibrate a display device to achieve a desired aspect ratio in accordance with some embodiments of the invention; and

FIG. 5 shows an example of a test image that can be used to certify and/or calibrate a display device to achieve desired color balance in accordance with some embodiments of the invention.

### DETAILED DESCRIPTION

Mechanisms (which can be systems, methods, media, etc.) for calibrating a display device are provided. For example, the mechanisms can be used to automatically certify and/or calibrate a display device using specialized test streams.

In some embodiments, a certification test can be performed on a display device by causing a test stream to be displayed on the display device. For example, a streaming media device can transmit a test stream (e.g., a video stream, etc.) to a display device. The display device can then display the test stream on a suitable screen.

In some embodiments, a test stream can include one or more test images that can be used to measure the performance of a display device. For example, one or more of the test images can include a test pattern including suitable geometric shapes (e.g., squares, circles, etc.), color bars, grayscale bars, any other suitable patterns, or any suitable combination thereof. In a more particular example, a test pattern can include a square and a circle and can be used to determine whether a display device can display a video stream with an appropriate aspect ratio. In another more particular example, a test pattern can include a set of grayscale bars that can be used to measure a black level, a white level, a color balance, and/or other settings of a display device.

In some embodiments, the mechanisms can capture one or multiple images of a test stream displayed on a display device to determine whether the display device can render the test stream in a desired manner. For example, one or more screenshots can be captured when a test stream is being displayed on the display device. In a more particular example, a screenshot of a test image displayed on a display device can be retrieved from a frame buffer of the display device. As another example, while a test stream is being displayed on a screen of a display device, the mechanisms can take one or multiple pictures of the screen of the display device using a suitable sensor, such as a camera, a camcorder, etc.

Upon capturing one or more images of a displayed test stream, the mechanisms can determine whether the test stream is displayed in a desired manner. For example, the mechanisms can detect a test pattern in the captured image(s) and determine whether the test pattern is displayed with distortions (e.g., with geometric distortions, color distortions, etc.). In response to detecting that the test pattern is displayed in a desired manner, the mechanisms can determine that the display device has passed the certification test. Alternatively, in response to detecting that the test pattern is displayed in a distorted manner, the mechanisms can determine that the display device has failed the certification test.

In a more particular example, in some embodiments in which a test pattern including a square and a circle is used in the certification test, the mechanisms can detect the displayed test pattern by extracting a rectangular structure and/or a circular structure from the captured image using suitable image processing techniques. In some embodiments, in response to detecting a square and/or a circle in the captured image, the mechanisms can determine that the display device can render a video stream with a desired aspect ratio and thus has passed the certification test. Alternatively, in response to detecting a rectangle and/or an ellipse in the captured image, the mechanisms can determine that the display device has failed the certification test.

In another more particular example, in some embodiments in which a test pattern including a set of grayscale bars is used in the certification test, the mechanisms can identify a region of interest (ROI) containing the test pattern in the captured image (e.g., by detecting a border of the test pattern). The mechanisms can then determine whether a color component (e.g., red, green, blue, etc.) is present within the ROI. In some embodiments, in response to determining that the ROI contains only grayscale components, the mechanisms can determine that the display device can render video streams with appropriate color balance, white-level, black-level, etc. Alternatively, in response to detecting color components other than the grayscale components within the ROI, the mechanisms can determine that the display device has failed the certification test.

In some embodiments, in response to determining that the display device has failed the certification test, the mechanisms can automatically generate a set of calibration instructions based on the detected test pattern. The mechanisms can then calibrate the display device based on the calibration instructions to achieve desired display performance. In some embodiments, upon calibrating the display device based on the set of instructions, the mechanisms can cause the test stream to be redisplayed to determine whether the display device can pass the certification test. The mechanisms can also recalibrate the display device if recalibration is necessary to achieve desired display performance.

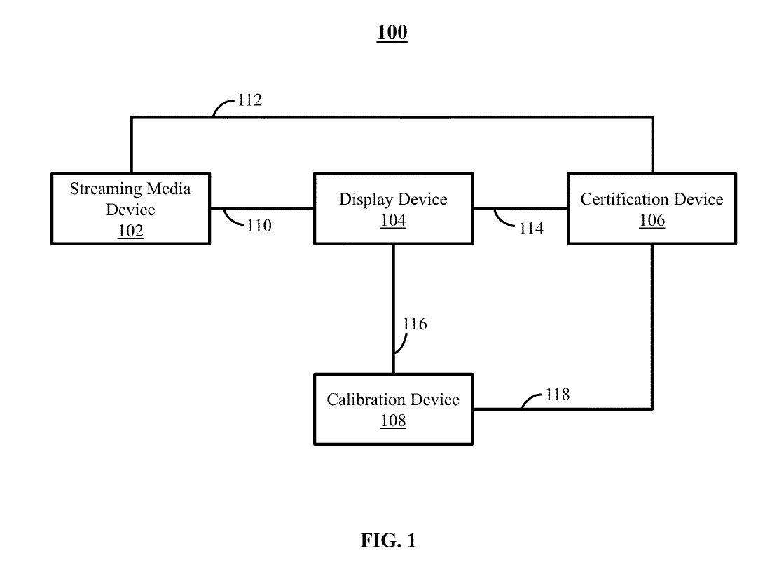

Turning to FIG. 1, a generalized block diagram of an example 100 of an architecture of hardware that can be used to stream media content in accordance with some embodiments is shown. As illustrated, architecture 100 can include a streaming media device 102, a display device 104, a certification device 106, a calibration device 108, and communications paths 110, 112, 114, 116, and 118.

In some embodiments, streaming media device 102 can include any suitable circuitry that is capable of receiving, converting, processing, rendering, and/or transmitting media content, and/or performing other suitable functions. For example, streaming media device 102 can include a set-top box, a digital media receiver, a DVD player, a BLU-RAY player, a game console, a desktop computer, a laptop computer, a tablet computer, a mobile phone, etc., and/or any other suitable combination of the same.

As another example, streaming media device 102 can include one or more types of content distribution equipment for distributing any suitable media content, including television distribution facility equipment, cable system head-end equipment, satellite distribution facility equipment, programming source equipment (e.g., equipment of television broadcasters, such as NBC, ABC, HBO, etc.), intermediate distribution facility equipment, Internet provider equipment, on-demand media server equipment, and/or any other suitable media content provider equipment. NBC is a trademark owned by the National Broadcasting Company, Inc., ABC is a trademark owned by the ABC, INC., and HBO is a trademark owned by the Home Box Office, Inc.

In some embodiments, streaming media device 102 can provide display device 104 with one or more specialized test streams including one or multiple test images to certify and/or calibrate display device 104. In some embodiments, each of the test images can contain a test pattern including suitable geometric shapes (e.g., squares, rectangles, circles, etc.), color bars, grayscale bars, etc., and/or any suitable combinations of these test patterns.

Streaming media device 102 may be operated by the originator of content (e.g., a television broadcaster, a Webcast provider, etc.) or may be operated by a party other than the originator of content (e.g., an on-demand content provider, an Internet provider of content of broadcast programs for downloading, etc.).

Streaming media device 102 may be operated by one or more cable providers, satellite providers, on-demand providers, Internet providers, providers of over-the-top content, and/or any other suitable provider(s) of content.

Streaming media device 102 may include a remote media server used to store different types of content (including video content selected by a user) in a location remote from any of the user equipment devices. For example, streaming media device 102 can include one or more content delivery networks (CDN).

As referred to herein, the term “media content” or “content” should be understood to mean one or more electronically consumable media assets, such as television programs, pay-per-view programs, on-demand programs (e.g., as provided in video-on-demand (VOD) systems), Internet content (e.g., streaming content, downloadable content, Webcasts, etc.), movies, films, video clips, audio, audio books, and/or any other media or multimedia and/or combination of the same. As referred to herein, the term “multimedia” should be understood to mean media content that utilizes at least two different content forms described above, for example, text, audio, images, video, or interactivity content forms. Media content may be recorded, played, displayed or accessed by user equipment devices, but can also be part of a live performance. In some embodiments, media content can include over-the-top (OTT) content. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC.

Media content can be provided from any suitable source in some embodiments. In some embodiments, media content can be electronically delivered to a user's location from a remote location. For example, media content, such as a Video-On-Demand movie, can be delivered to a user's home from a cable system server. As another example, media content, such as a television program, can be delivered to a user's home from a streaming media provider over the Internet.

Display device 104 can include any suitable circuitry that is capable of decoding, encoding, and/or rendering media content, such as video content, audio content, etc. For example, display device 104 can include a streaming media player, a media center computer, a CRT display, an LCD, an LED display, a plasma display, a touch-screen display, a simulated touch screen, a television device, a tablet user input device, a mobile phone, etc. In some embodiments, display device 104 can present a user with three-dimensional content.

Certification device 106 can include any circuitry that is capable of capturing, processing, and/or analyzing an image of media content being displayed on display device 104, and/or performing any other suitable functions. For example, certification device 106 can include a screenshot application that is capable of taking a screenshot of a screen of display device 104, an active window application rendered on the screen, and/or any suitable portion of the screen while media content is displayed on display device 104. As another example, certification device 106 can include a video recorder that can receive and record video data (e.g., still images, moving images, etc.) supplied from display device 104, such as a digital video recorder (DVR), etc. In some embodiments, certification device 106 can be integrated with other devices, such as a set-top box (STB), a streaming media device, a camcorder, a DVD player, etc. As yet another example, certification device 106 can include one or more sensors that can take still images and/or moving images of the screen of display device 104, such as a camera, a camcorder, etc.

Calibration device 108 can contain any suitable circuitry that is capable of receiving, processing, and/or executing calibration instructions and/or performing other suitable functions. In some embodiments, for example, calibration device 108 can receive a set of calibration instructions and generate a control signal to adjust an aspect ratio, a black-level, a white-level, a color balance, and/or any other settings of display device 104.

In some embodiments, each of streaming media device 102, display device 104, certification device 106, and calibration device 108 can be implemented in any suitable hardware. For example, each of streaming media device 102, display device 104, certification device 106, and calibration device 108 can be implemented in any of a general purpose device such as a computer or a special purpose device such as a client, a server, a mobile terminal (e.g., a mobile phone), etc. Any of these general or special purpose devices can include any suitable components such as a hardware processor (which can be a microprocessor, digital signal processor, a controller, etc.). In some embodiments, each of streaming media device 102, display device 104, certification device 106, and calibration device 108 can include a suitable storage device, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same.

In some embodiments, each of streaming media device 102, display device 104, certification device 106, and calibration device 108 can be implemented as a stand-alone device or integrated with other components of architecture 100. For example, in some embodiments, one or both of certification device 106 and calibration device 108 can be integrated with streaming media device 102. As another example, one or more of streaming media device 102, certification device 106, and calibration device 108 can be integrated with display device 104.

In some embodiments, streaming media device 102 can be connected to display device 104 and certification device 106 through communications paths 110 and 112, respectively. In some embodiments, display device 104 can be connected to certification device 106 and calibration device 108 through communications paths 114 and 116, respectively. In some embodiments, certification device 106 can be connected to calibration device 108 through communication path 118.

Communications paths 110, 112, 114, 116, and 118 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths, in some embodiments.

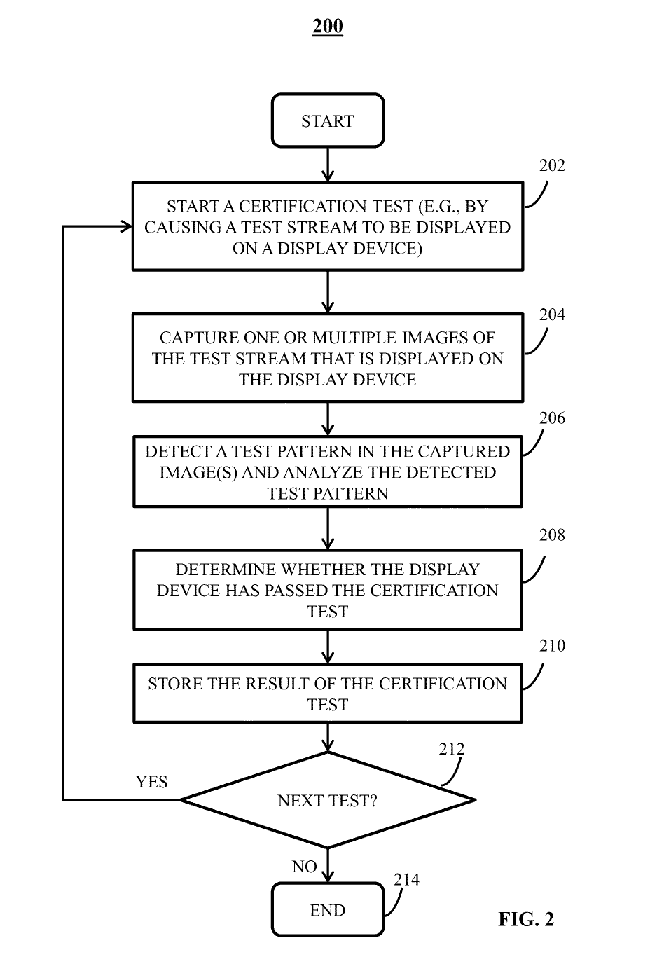

Turning to FIG. 2, an example 200 of a process for certifying a display device in accordance with some embodiments of the disclosed subject matter is shown. In some embodiments, process 200 can be implemented by one or more components of architecture 100 of FIG. 1, such as streaming media device 102, display device 104, certifying device 106, etc.

As illustrated, process 200 can begin by starting a certification test by causing a test stream to be displayed on a display device at 202. For example, a streaming media device can transmit the test stream to the display device. The display device can then display the test stream on a screen.

In some embodiments, any suitable test stream can be used to certify and/or calibrate the display device. For example, the test stream can contain one or multiple test images that can be used to measure the performance of the display device. More particularly, for example, the test images can be used to determine whether the display device can render media content (e.g., video streams transmitted from a streaming media device or other suitable source) with a desired aspect ratio, a black-level (e.g., brightness), a white-level (e.g., contrast), a color balance, a tint level, a saturation level, a sharpness level, etc. In some embodiments, each of the test images can contain a test pattern including suitable geometric shapes (e.g., squares, circles, etc.), color bars, grayscale bars, etc., any other suitable patterns, and/or any suitable combination thereof.

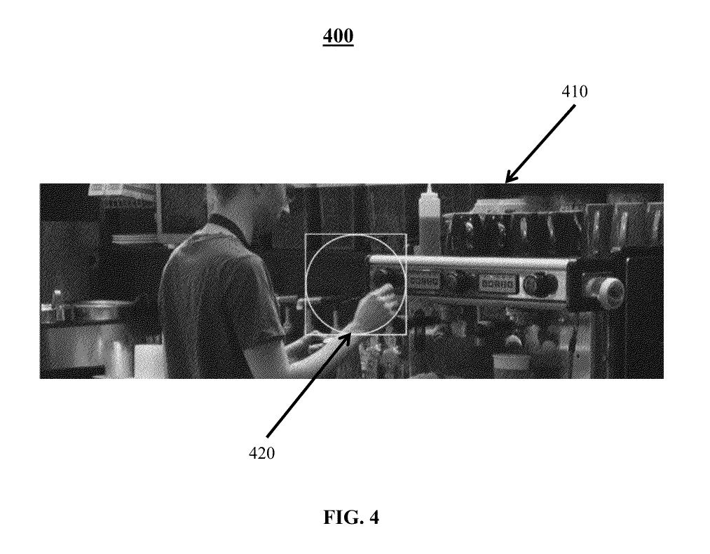

In a more particular example, as illustrated in FIG. 4, the test stream can include a test image 400 that can be used to measure whether the display device renders a video stream with a desired aspect ratio. As shown, test image 400 can include a test pattern 410 containing a circle and a square. The circle and the square can be positioned in any suitable manner. In some embodiments, for example, the square can overlap the circle. In some embodiments, when the display device renders the test stream with an inappropriate aspect ratio, the test pattern may be displayed with distortions. More particularly, for example, the square may be displayed as a rectangle while the circle may be displayed as an ellipse.

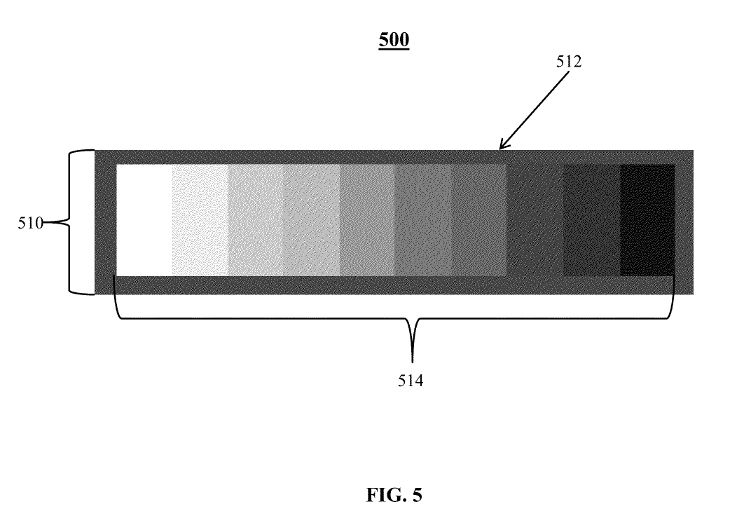

In another more particular example, as illustrate in FIG. 5, the test stream can include a test image 500 that can be used to measure whether the display device renders a video stream with proper black-level (e.g., brightness), white-level (e.g., contrast), and/or color balance (e.g., RGB balance). As shown, test image 500 can include a test pattern 510 containing a border 512 and a set of grayscale bars 514. In some embodiments, border 512 can define the boundary of test pattern 510 using a suitable color, such as red, green, blue, etc. In some embodiments grayscale bars 514 can include a set of vertical and/or horizontal grayscale bars, each of which can have a particular intensity ranging from 0 (e.g., black) to 255 (e.g., white).

In yet another more particular example, the test stream can include one or more test images that can be used to measure whether the display device can render text (e.g., alphanumeric content) in an appropriate manner. In some embodiments, for example, each of the test images can include a test pattern containing one or more of letters, numbers, characters, etc. that have a particular font, a particular size, and/or other predetermined characteristics.

Referring back to FIG. 2, at 204, process 200 can capture one or multiple images of the test stream that is displayed on the display device. In some embodiments, the images can be captured by the certification device in a suitable manner. For example, the certification device can capture one or more screenshots of the displayed test stream. In a more particular example, the certification device can capture a screenshot of the test image that is displayed on the display device. More particularly, for example, while the test image is being displayed on the display device, the certification device can capture a screenshot of the screen of the display device, an active window application rendered on the screen, and/or any suitable portion of the screen. In some embodiments, the certification device can retrieve an image of the media content displayed on the display device from a frame buffer in the display device. In another more particular example, the certification device can record the screen output of the display device while the test stream is being displayed. The certification device can then generate a set of images of the displayed test stream (e.g., a screencast, etc.).

As another example, the certification device can take one or more pictures of the test stream being displayed on the display device. In a more particular example, the certification device can control one or multiple cameras (e.g., built-in cameras, external cameras, etc.) to take one or more pictures of the screen of the display device or a suitable portion of the screen while the test stream is being displayed on the display device.

As yet another example, the certification device can intercept video output of the display device and extract one or more images (e.g., screenshots, screencast, etc.) from the intercepted video output. In a more particular example, the certification device can intercept display commands that are generated by the display device and used to render the test stream. The certification device can then display the test stream and/or capture screenshots of the displayed test stream based on the intercepted display commands.

In some embodiments, the image(s) of the displayed test stream can be saved in a suitable format (e.g., JPEG, PNG, GIF, PDF, HTML, etc.). In some embodiments, the image(s) of the displayed test stream can also be transmitted to a suitable device (e.g., the certification device, the calibration device, a remote server, etc.).

At 206, process 200 can detect a test pattern in the captured image(s) and analyze the detected test pattern. For example, the certification device can extract a particular geometric shape (e.g., a rectangle, a square, a circle, an ellipse, etc.) within a test pattern using suitable image processing techniques, such as edge detection, feature extraction, template matching, object detection and tracking, etc. More particularly, for example, the certification device can identify the geometric shape and determine the position, orientation, size, and/or other characteristics of the geometric shape. In a more particular example, the certification device can detect the particular geometric shape in the captured image by thresholding the captured image at a suitable brightness or intensity level. Additionally or alternatively, the certification device can detect the particular geometric shape by subtracting a background image from the captured image or the thresholded image. In another more particular example, the certification device can match a template image (e.g., a binary image, an edge map, a color image, etc. that includes the particular geometric shape to be detected) to the captured image. In some implementations, the particular geometric shape can be detected by searching for the best correlation between the template image and the captured image. In yet another more particular example, the certification device can perform a Hough Transform on the captured image (e.g., by mapping pixels of the captured image into an accumulator space or Hough space). The certification device can then extract lines, circles, ellipses, etc. from the transformed image.

In some embodiments, test image 400 of FIG. 4 can be used to measure the performance of the display device (e.g., an aspect ratio, etc.). In such an example, the certification device can detect a rectangular structure and/or a circular structure in the image captured at 204.

As another example, the certification device can detect a region of interest (ROI) including the test pattern rendered by the display device. In a more particular example, in some embodiments in which test image 500 of FIG. 5 is rendered by the display device, the certification device can detect border 512 that defines a ROI including test pattern 510. The certification device can then analyze test pattern 510 and detect the color components contained in test pattern 510.

As yet another example, the certification device can detect a text pattern containing letters, numbers, characters, etc. in the captured image(s). The certification device can then analyze the text pattern and determine the font, the size, and/or other characteristics of the text pattern. Additionally or alternatively, the certification device can determine whether the text pattern contains any distortions, such as overlapping text, distorted curves, lines, and/or other components of the displayed text (e.g., letters, numbers, characters, etc.), etc.

Referring back to FIG. 2, at 208, process 200 can determine whether the display device has passed the certification test. In some embodiments, such determination can be made by the certification device in a suitable manner. For example, the certification device can determine whether the detected test pattern is displayed in a desired manner. In response to determining that the detected test pattern is displayed in the desired manner, the certification device can determine that the display device has passed the certification test. Otherwise, the certification device can determine that the display device has failed the certification test.

In a more particular example, in some embodiments in which test image 400 of FIG. 4 is used to measure the performance of the display device, the certification device can determine whether the detected rectangular structure in the captured image(s) is a square. Alternatively or additionally, the certification device can determine whether the detected circular structure in the captured image(s) is a circle. In some embodiments, in response to detecting a square and/or a circle in the captured image(s), the certification device can determine that the display device can display the test stream with an appropriate aspect ratio and thus has passed the certification test. Alternatively, in response to detecting a rectangle and/or an ellipse, the certification device can determine that the display device has failed the certification test.

In another more particular example, in some embodiments in which test image 500 of FIG. 5 is used to measure the color balance of the display device, the certification device can determine whether the ROI contains only grayscale components. In some embodiments, in response to determining that the ROI contains only grayscale components, the certification device can determine that the display device has passed the grayscale test. Alternatively, in response to detecting a color component (e.g., red, green, blue, etc.) within the ROI, the certification device can determine that the display device has failed the grayscale certification test.

In yet another more particular example, in some embodiments in which the text pattern is used to measure the display performance of the display device, the certification device can determine whether the detected text has a desired font, a desired size, and/or other desired characteristics. In some embodiments, in response to determining that the text has a desired font, a desired size, etc. and/or that the text does not contain any distortions, the certification device can determine that the display device has passed the text pattern test. Alternatively, in response to determining that the text has an inappropriate font, an inappropriate size, and/or other characteristics and/or that the text contains distortions (e.g., overlapping text, distorted curves, lines, etc.), the certification device can determine that the display device has failed the text pattern test.

In some embodiments, at 212, the certification device can store the result of the certification test in a suitable storage device. In some embodiments, the result of the certification test can be presented to a user using one or more suitable user interfaces.

At 212, process 200 can determine whether one or more certification tests need to be performed on the display device. In some embodiments, in response to determining that one or more certification tests need to be performed on the display device, process 200 can loop back to step 202. For example, the certification device can generate a control signal indicating that a next certification test needs to be performed. The certification device can then transmit the control signal to the streaming media device. In response to receiving the control signal, the streaming media device can provide the display device with a second test stream to perform the next certification test. In some embodiments, the second test stream can include one or more test images with embedded test pattern(s). In a more particular example, in the embodiments where a video stream including test image 400 (FIG. 4) has been provided to the display device as the first test stream, streaming media device can provide a test stream including test image 500 (FIG. 5) to the display device in response to receiving the control signal.

Alternatively, in response to determining that all of the certification tests have been completed, process 200 can end at 214.

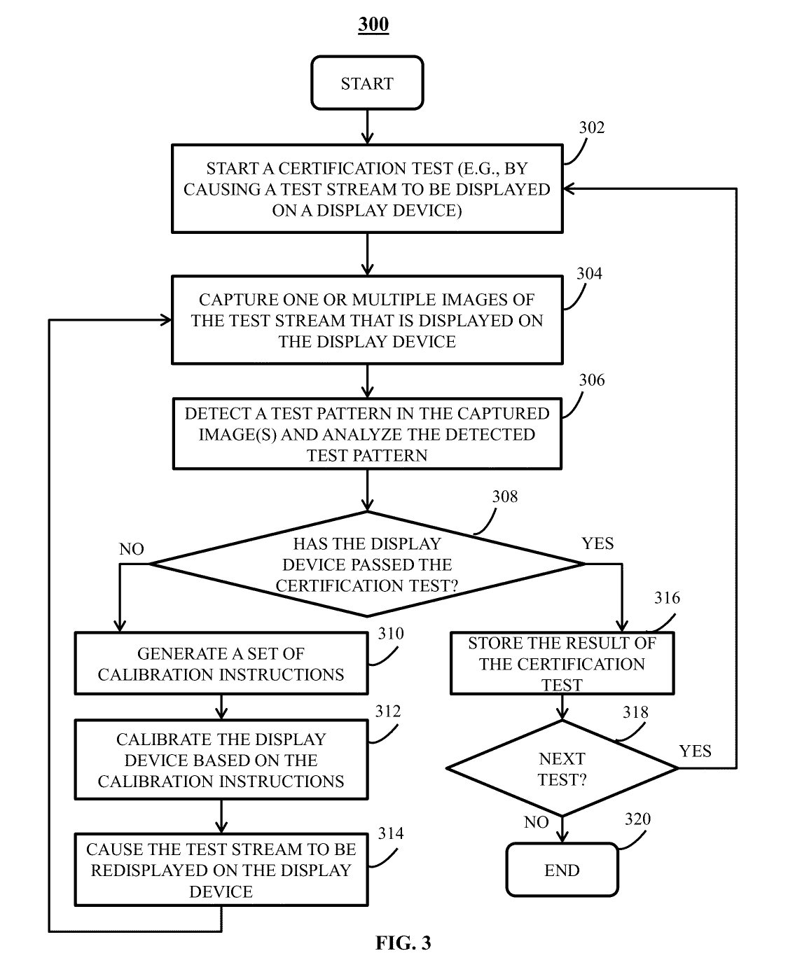

Turning to FIG. 3, an example 300 of a process for certifying and calibrating a display device in accordance with some embodiments of the disclosed subject matter is shown. In some embodiments, process 300 can be implemented by one or more components of architecture 100 of FIG. 1, such as streaming media device 102, display device 104, certification device 106, calibration device 108, etc.

As illustrated, process 300 can start by causing a test stream to be displayed on a display device at 302. Step 302 can be performed in substantially the same manner as step 202 of FIG. 2. Process 300 can then be advanced to 304-308, which can be performed in substantially the same manner as steps 204-208 of FIG. 2, respectively.

In some embodiments, in response to determining that the display device has not passed the certification test, the certification device can generate a set of calibration instructions that can be used to calibrate the display device to achieve desired display performance at 310. For example, the certification device can generate a set of instructions that can instruct a calibration device to adjust an aspect ratio, a brightness level, a contrast level, a color balance, a saturation level, a sharpness level, a resolution, a scaling option, a refresh rate, and/or any other display settings of the display device.

In a more particular example, in some embodiments in which test image 500 of FIG. 5 is used to measure the display performance of the display device, the certification device can generate one or more calibration instructions indicating that one or more color levels (e.g., red, green, blue, etc.) of the display device should be adjusted. In some embodiments, for example, in response to detecting red components within ROI 512, the certification device can generate one or more instructions to raise the color temperature of the display device, decrease the red component of the display device, and/or increase the blue component and/or green component of the display device. As another example, in response to detecting blue components within ROI 512, the certification device can generate one or more instructions to reduce the color temperature of the display device, increase the red component of the display device, and/or decrease the blue component and/or green component of the display device.

Referring back to FIG. 3, at 312, the display device can be calibrated based on the set of calibration instructions. In some embodiments, a calibration device can calibrate the display device based on the set of calibration instructions generated by the certification device. For example, the calibration device can receive the calibration instructions generated by the certification device through a suitable communication link. The calibration device can then process the calibration instructions and adjust an aspect ratio, a brightness level, a contrast level, a color balance, a saturation level, a sharpness level, and/or any other settings of the display device based on the processed calibration instructions.

Additionally or alternatively, the calibration device can convert the calibration instructions into one or more control signals. The calibration device can then transmit the control signals to the display device. In some embodiments, in response to receiving the control signals, the display device can adjust an aspect ratio, a brightness level, a contrast level, a color balance, a saturation level, a sharpness level, and/or any other settings of the display device based on the control signals.

Next, at 314, the test stream that has been displayed prior to the calibration can be redisplayed on the display device. For example, upon adjusting the display settings of the display device, the calibration device can cause the test stream to be displayed on the display device using the adjusted display settings.

In some embodiments, process 300 can loop back to step 304 after 314 is performed. For example, one or more images of the redisplayed test stream can be captured by the certification device in a suitable manner. The certification device can then detect and analyze the test pattern embedded in the captured images and determine whether the display device has passed the certification/calibration test.

Alternatively, in response to determining that the display device has passed the certification test, the certification can save the result of the certification test in a suitable storage device at 316. In some embodiments, the certification device can also determine whether more certification tests need to be performed on the display device at 318.

In some embodiments, in response to determining that one or more certification need to be performed on the display device, certification device can generate a control signal indicating that a next certification test needs to be performed and transmit the control signal to the steaming media device. In response to receiving the control signal, the streaming media device can provide the display device with a second test stream including at least one test image with embedded test pattern(s).

Alternatively, in response to determining that all of the certification tests have been performed, process 300 can end at 320.

It should be noted that process 200 of FIG. 2 and process 300 of FIG. 3 can be performed concurrently in some embodiments. It should also be noted that the above steps of the flow diagrams of FIGS. 2-3 may be executed or performed in any order or sequence not limited to the order and sequence shown and described in the figures. Furthermore, it should be noted, some of the above steps of the flow diagrams of FIGS. 2-3 may be executed or performed substantially simultaneously where appropriate or in parallel to reduce latency and processing times. And still furthermore, it should be noted, some of the above steps of the flow diagrams of FIGS. 2-3 may be omitted.

In some embodiments, any suitable computer readable media can be used for storing instructions for performing the mechanisms and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above described embodiments of the present disclosure are presented for purposes of illustration and not of limitation, and the present disclosure is limited only by the claims which follow.

What is claimed is:

1. A method for calibrating a display device, the method comprising:
causing a first test stream to be displayed on the display device;
capturing, using a hardware processor, at least one screenshot of the first test stream displayed on the display device;
detecting, using the hardware processor, a first test pattern in the screenshot;
determining, using the hardware processor, whether the first test pattern contains a distortion; and
generating, using the hardware processor, a set of instructions to calibrate the display device in response to determining that the first test pattern contains a distortion.

2. The method of claim 1, wherein the distortion includes a geometric distortion.

3. The method of claim 1, wherein the distortion includes a color distortion.

4. The method of claim 1, further comprising causing a second test stream to be displayed on the display device in response to determining that the first test pattern does not contain a distortion.

5. The method of claim 4, further comprising:
capturing at least one screenshot of the second test stream displayed on the display device;
detecting a second test pattern in the screenshot of the second test stream; and
determining whether the second test pattern contains a distortion.

6. The method of claim 1, further comprising:
detecting a rectangle in the screenshot;
determining whether the rectangle is a square; and
determining that the first test pattern contains a distortion in response to determining that the rectangle is not a square.

7. The method of claim 1, wherein the test pattern contains a plurality of grayscale bars.

8. The method of claim 7, further comprising:
identifying a region of interest containing the plurality of grayscale bars in the screenshot; and
determining that the test pattern contains a distortion in response to detecting a color component in the region of interest.

9. A system for calibrating a display device, the system comprising:
at least one hardware processor that is configured to:
cause a first test stream to be displayed on the display device;
capture at least one screenshot of the first test stream displayed on the display device;
detect a first test pattern in the screenshot;
determine whether the first test pattern contains a distortion; and
generate a set of instructions to calibrate the display device in response to determining that the first test pattern contains a distortion.

10. The system of claim 9, wherein the distortion includes a geometric distortion.

11. The system of claim 9, wherein the distortion includes a color distortion.

12. The system of claim 9, wherein the hardware processor is further configured to cause a second test stream to be displayed on the display device in response to determining that the first test pattern does not contain a distortion.

13. The system of claim 12, wherein the hardware processor is further configured to:
capture at least one screenshot of the second test stream displayed on the display device;
detect a second test pattern in the screenshot of the second test stream; and
determine whether the second test pattern contains a distortion.

14. The system of claim 9, wherein the hardware processor is further configured to:
detect a rectangle in the screenshot;
determine whether the rectangle is a square; and
determine that the first test pattern contains a distortion in response to determining that the rectangle is not a square.

15. The system of claim 9, wherein the test pattern contains a plurality of grayscale bars.

16. The system of claim 15, wherein the hardware processor is further configured to:
identify a region of interest containing the plurality of grayscale bars in the screenshot; and
determine that the test pattern contains a distortion in response to detecting a color component in the region of interest.

17. A non-transitory computer-readable medium containing computer-executable instructions that, when executed by a processing circuitry, cause the processing circuitry to perform a method for calibrating a display device, the method comprising:
causing a first test stream to be displayed on the display device;
capturing at least one screenshot of the first test stream displayed on the display device;
detecting a first test pattern in the screenshot;
determining whether the first test pattern contains a distortion; and
generating a set of instructions to calibrate the display device in response to determining that the first test pattern contains a distortion.

18. The non-transitory computer-readable medium of claim 17, wherein the distortion includes a geometric distortion.

19. The non-transitory computer-readable medium of claim 17, wherein the distortion includes a color distortion.

20. The non-transitory computer-readable medium of claim 17, wherein the method further comprises causing a second test stream to be displayed on the display device in response to determining that the first test pattern does not contain a distortion.

21. The non-transitory computer-readable medium of claim 20, wherein the method further comprises:
capturing at least one screenshot of the second test stream displayed on the display device;
detecting a second test pattern in the screenshot of the second test stream; and
determining whether the second test pattern contains a distortion.

22. The non-transitory computer-readable medium of claim 17, wherein the method further comprises:
detecting a rectangle in the screenshot;
determining whether the rectangle is a square; and
determining that the first test pattern contains a distortion in response to determining that the rectangle is not a square.

23. The non-transitory computer-readable medium of claim 17, wherein the test pattern contains a plurality of grayscale bars.

24. The non-transitory computer-readable medium of claim 23, wherein the method further comprises:
identifying a region of interest containing the plurality of grayscale bars in the screenshot; and
determining that the test pattern contains a distortion in response to detecting a color component in the region of interest.
